(19) United States
(12) Patent Application Publication
(10) Pub. No.: US 2015/0343585 A1
(43) Pub. Date: Dec. 3, 2015

(54) CENTRIFUGAL STATION AND COMPRESSED AIR CLEANING ARRANGEMENT

(71) Applicant: Liebherr-Verzahntechnik GmbH, Kempten/Allgaeu (DE)

(72) Inventor: Johannes Weixler, Durach (DE)

(21) Appl. No.: 14/716,660

(22) Filed: May 19, 2015

(30) Foreign Application Priority Data
May 27, 2014 (DE) 10 2014 008 022.6
Jul. 25, 2014 (DE) 10 2014 011 133.4

(51) Int. Cl. B23Q 11/00; B23F 23/00; B08B 5/02

(52) U.S. Cl. CPC B23Q 11/0075; B08B 5/02; B23F 23/00

(57) ABSTRACT

The present disclosure shows a centrifugal station for removing a machining fluid from workpieces, comprising a workpiece mount which is set into rotation by a drive to liberate a workpiece which is received in the workpiece mount from adhering machining fluid. In this respect, the centrifugal station has a compressed air cleaning arrangement which removes machining fluid adhering to a region of the workpiece by blowing with compressed air. The present disclosure furthermore comprises a corresponding compressed air cleaning arrangement for the removal of a machining fluid from geared workpieces, wherein the compressed air cleaning arrangement removes machining fluid adhering in a region of the workpiece by blowing with compressed air.

### CROSS REFERENCE TO RELATED APPLICATION

This application claims priority to German Patent Application No. 10 2014 008 022.6, entitled “Centrifugal Station and Compressed Air Cleaning Arrangement” filed on May 27, 2014, and also claims priority to German Patent Application No. 10 2014 011 133.4, entitled “Centrifugal Station and Compressed Air Cleaning Arrangement”, filed Jul. 25, 2014, the entire contents of each of which are hereby incorporated by reference in their entirety for all purposes.

### TECHNICAL FIELD

The present disclosure relates to a centrifugal station and/or to a compressed air cleaning arrangement for removing machining fluid remaining on a workpiece after a machining. The present disclosure in this respect in particular relates to the removal of a machining fluid from geared workpieces.

### BACKGROUND AND SUMMARY

When gear cutting workpieces, and for example on a hard fine machining, a machining fluid, for example a cooling oil or a cooling lubricant, is used to cool the workpiece and the tool. It remains adhered to the workpiece after its machining.

Users of gear cutting machines, however, are making ever higher demands on the freedom from oil of the workpieces for the further machining. It is known in this respect to use a centrifugal station for removing the machining fluid. Such a centrifugal station in this respect has a workpiece mount which may be set into rotation by a drive to liberate a workpiece which may be received in the workpiece mount from adhering machining fluid. The removal of the machining fluid thus takes place by the centrifugal force generated by the rotation. Such a centrifugal station is known, for example, from DE 10 2005 043 602.

The centrifugal station in this respect relatively easily removes machining fluid adhering to the workpiece at the outside. Workpieces having inwardly disposed regions are, however, difficult to liberate from machining fluid by a centrifugal station. The removal on the outside is furthermore also not ideal.

It is therefore the object of the present disclosure to improve the removal of machining fluid from workpieces, for example from geared workpieces.

This object is achieved in accordance with the present disclosure by a centrifugal station removing a machining fluid from workpieces, comprising a workpiece mount which is set into rotation by a drive to liberate a workpiece which is received in the workpiece mount from adhering machining fluid, wherein the centrifugal station has at least one compressed air cleaning arrangement which removes machining fluid adhering on a region of the workpiece by blowing with compressed air.

The present disclosure provides a centrifugal station for removing a machining fluid from workpieces, for example from geared workpieces. The centrifugal station has a workpiece mount which may be set into rotation by a drive to liberate a workpiece which may be received in the workpiece mount from adhering machining fluid. In accordance with the present disclosure, the centrifugal station has at least one compressed air cleaning arrangement which removes machining fluid adhering to a region of the workpiece by blowing with compressed air. The compressed air cleaning arrangement may in this respect in particular remove machining fluid adhering to an inwardly disposed region of the workpiece and/or adhering to an outwardly disposed region of the workpiece by blowing with compressed air.

A considerably improved removal of machining fluid is achieved by the blowing with compressed air in accordance with the present disclosure. The compressed air cleaning arrangement in accordance with the present disclosure thus allows the removal of machining fluid from those region of the workpiece from which it cannot be removed or from which it may only be removed with difficulty by centrifuging on the centrifugal station and/or allows an additional cleaning of the outer periphery of the workpieces, for example. The present disclosure thus provides a substantially better liberation from machining fluid.

The compressed air cleaning arrangement in accordance with the present disclosure is configured as a compressed air lance in a first embodiment. The compressed air lance may for example be used for cleaning a bore of the workpiece.

The compressed air cleaning arrangement in accordance with the present disclosure may in this respect comprise a bar in whose head region a compressed air outlet is arranged. This compressed air outlet may for example be in communication with a compressed air source through a longitudinal bore of the bar.

The compressed air cleaning arrangement in accordance with the present disclosure may be introduced into a borehole of the workpiece, and thus clean it in a targeted manner, by the embodiment of the compressed air cleaning arrangement as a compressed air lance or as a bar having a compressed air outlet arranged in the head region. The compressed air cleaning arrangement in this respect may have an outer diameter which is smaller than the inner diameter of the bore to be cleaned.

The compressed air cleaning arrangement in accordance with the present disclosure is configured in a second embodiment as an outer periphery cleaner which may be used for cleaning the outer periphery of the workpiece with compressed air.

The outer periphery cleaner may have a compressed air outlet which extends in the form of one or more nozzles about a central cleaning region. The workpiece may be arranged in the central cleaning region such that its outer periphery is blown onto and cleaned by compressed air which flows from the compressed air outlet.

The compressed air outlet of the outer periphery cleaner may for example be a ring nozzle. Alternatively, however, a plurality of punctiform or linear nozzles may also be arranged in ring form about the central cleaning region.

The air outlet and in particular the one or more nozzles are preferably obliquely inwardly directed. In this respect, the air may flow to the plane of the air outlet and/or to the longitudinal axis of the workpiece at an angle between 10° and 80° in example, and between 20° and 70° in another example. The machining fluid is hereby moved by the air flow in an axial direction on the outer periphery of the workpiece.

The centrifugal station further may have a travel arrangement by which a compressed air outlet of the compressed air cleaning arrangement may be traveled with respect to the workpiece. In this respect, the compressed air cleaning arrangement for example the compressed air lance and/or the outer periphery cleaner, may be traveled as a whole. The traveling in this respect makes it possible to conduct the compressed air outlet directly past regions of the workpiece which are to be cleaned.

In a possible embodiment, the compressed air cleaning arrangement, in particular the compressed air lance, may be traveled through a bore of the workpiece. The compressed air cleaning arrangement, for example the compressed air lance, may be connected to the traveling arrangement in an end region disposed opposite the compressed air outlet and may be displaceable in a guide in the longitudinal direction.

In a further embodiment, the compressed air cleaning arrangement, for example the outer periphery cleaner, may be traveled along the outer periphery of the workpiece in parallel with the longitudinal axis of the workpiece and/or in parallel with the axis of rotation of the centrifugal station.

The cleaning of the workpiece by the compressed air cleaning arrangement may be carried out during the centrifuging of the workpiece. The compressed air cleaning arrangement may, for example, be used for cleaning a shaft bore of the workpiece, e.g., for a bore provided centrally within the workpiece, and/or for cleaning the outer periphery.

The centrifugal station in accordance with the present disclosure may, in one embodiment, comprise two compressed air cleaning arrangements, for example two different compressed air cleaning arrangements and/or two compressed air cleaning arrangements for cleaning different regions of the workpiece, for example a compressed air lance and an outer periphery cleaner. The two compressed air cleaning arrangements may be traveled independently of one another. The two compressed air cleaning arrangements may for example have separate travel arrangements. A control may furthermore be provided via which the two compressed air cleaning arrangements may be traveled in parallel.

In an embodiment, the compressed air cleaning arrangement is arranged at a workpiece mount of the workpiece spindle and/or is conducted through a workpiece mount of the workpiece spindle. This, for example, makes it possible to clean a shaft bore of the workpiece by the compressed air cleaning arrangement, while the workpiece is clamped in the workpiece spindle of the centrifugal station.

The compressed air cleaning arrangement may be arranged at the lower workpiece mount of the workpiece spindle. In this respect, the axis of rotation of the workpiece spindle may extend vertically.

The compressed air cleaning arrangement may furthermore be arranged at a workpiece mount of the workpiece spindle which co-rotates with the workpiece without its own drive. The drive is thus attached to the workpiece mount of the workpiece spindle disposed opposite the compressed air cleaning arrangement. Too many components hereby do not have to be arranged at a single workpiece mount.

Further advantageously, the workpiece mount at which the compressed air cleaning arrangement is arranged may be traveled in the longitudinal direction. The workpiece mount may for example be traveled to the workpiece from below and may raise it so that it comes into engagement with the upper workpiece mount.

The compressed air cleaning arrangement may in this respect advantageously be traveled with respect to the workpiece mount and may for example be traveled into the shaft bore of a workpiece clamped on the workpiece spindle.

Provision may in this respect be made in accordance with the present disclosure that the compressed air cleaning arrangement may co-rotate with the workpiece mount of the workpiece spindle. The compressed air cleaning arrangement may be connected to a compressed air source via a rotary union for this purpose.

The compressed air cleaning arrangement may in this respect pass longitudinally displaceably through the workpiece mount. The compressed air cleaning arrangement is, for example, connected in a rear region to a travel arrangement through which it may travel through the workpiece mount into a shaft bore of the workpiece. The workpiece mount in this respect simultaneously serves as a guide for the longitudinal displacement of the compressed air cleaning arrangement.

The oppositely disposed workpiece mount may in this respect have a hollow space which extends the shaft bore and into which a head of the compressed air cleaning arrangement may at least partly be traveled. This makes it possible to travel the compressed air cleaning arrangement so far through the shaft bore that a compressed air outlet arranged in the head region of the shaft bore projects beyond the workpiece.

The workpiece is in this respect may be arranged at the lower workpiece mount such that machining fluid may run off out of the shaft bore of the workpiece. The workpiece mount may, for example, be a centering cone at whose outer periphery grooves are provided. The machining fluid and the compressed air may escape from the shaft bore through these grooves. The compressed air cleaning apparatus in this respect may pass through this centering cone centrally.

The upper workpiece mount of the workpiece spindle may in contrast sealingly terminate the shaft bore. The upper workpiece mount may, for example, have an inner contour with which it may be placed onto the upper side of the workpiece with frictional engagement. The sealing contact of the upper workpiece mount in this respect prevents compressed air from existing in this region.

The compressed air cleaning arrangement is in this respect may be configured such that the compressed air outlet of the compressed air cleaning arrangement conducts the compressed air flow obliquely rearwardly from a head region of the compressed air cleaning arrangement. The compressed air therefore flows back from the head region in a gap between the compressed air cleaning arrangement and the inner contour of the wave bore. For this purpose, an obliquely rearwardly orientated compressed air channel may be provided in the head region which leads to the compressed air outlet.

The compressed air cleaning arrangement may in this respect have a rod part and a head part, with the compressed air being supplied through a longitudinal bore in the interior of the rod part and being conducted outwardly to the compressed air outlet through a region remaining free between the rod part and the head part. The head part may, for example, be a separate element which is connected to the rod part.

The compressed air cleaning arrangement in this respect may have a substantially circular cross-section at least in the region of the compressed air outlet. The compressed air is in this respect may let out through the compressed air outlet in the peripheral direction. The compressed air outlet may in this respect comprise a plurality of openings which are provided in the peripheral direction at the compressed air cleaning arrangement and/or about a ring-shaped outlet which fully peripherally passes through the outer periphery of the compressed air cleaning arrangement.

In accordance with the present disclosure, the compressed air cleaning arrangement, or a part thereof, may be designed as a swappable part in order thus to be adapted to different workpieces. The compressed air cleaning arrangement may hereby, for example, be adapted to different internal diameters and/or outer diameters and/or lengths of the shaft bore or of the workpiece. For this purpose, however, only the head part of the compressed air cleaning arrangement may optionally be swapped.

Furthermore, one or both workpiece supports may be swappable parts. The centrifugal station may hereby be adapted to different workpieces.

The centrifugal station may have a respective rotational bearing with a bearing element into which the workpiece support is inserted in the region of one of the workpiece mounts, for example. A respective quick connector may be provided for this purpose.

The compressed air cleaning arrangement in this respect may form a part of the workpiece mount to be swapped and may be exchanged with it. The compressed air cleaning arrangement is in this respect furthermore may be connected in its rear region to the travel arrangement arranged there for mounting to the centrifugal station. The compressed air supply in this respect may take place through a rotary union with which the compressed air cleaning arrangement is in communication with the travel arrangement.

In a possible embodiment, the compressed air cleaning arrangement, for example the outer periphery cleaner, may comprise a nozzle body having a hollow space which is in communication with a compressed air source and supplies the nozzle or nozzles with compressed air.

The nozzle body may furthermore be arranged at a travel arrangement. The nozzle body may be traveled via the travel arrangement in parallel with the longitudinal axis of the workpiece along its outer periphery.

In this respect, the travel arrangement may be mounted at a spindle carrier.

The travel arrangement further may have a travel path which is larger or of the same size as the maximum spread of the workpiece mount.

In a possible embodiment, the compressed air cleaning arrangement, for example the outer periphery cleaner, may comprise a ring-shaped hollow body. The ring-shaped hollow space in the interior of the hollow body is in this respect in communication with a compressed air source. One or more nozzles through which compressed air is blown out may furthermore be arranged at an inner periphery of the hollow body. A ring nozzle may be provided, for example.

The nozzle body may be a swappable part. In this respect, the nozzle body may be releasably connectable to the travel arrangement.

The centrifugal station in accordance with the present disclosure has a control for actuating the compressed air cleaning arrangement and/or for traveling the compressed air cleaning arrangement. In this respect, the control may be configured such that the compressed air cleaning arrangement is first traveled into the bore of the workpiece, and is, for example, traveled completely through it, at a first speed and thereupon moves out again at second speed, for example a slow speed. In this respect, compressed air may be only blown out on the movement in one direction, for example on the downward movement of the compressed air cleaning arrangement. In this respect, compressed air may be only blown out on the moving out. The control may in this respect take place electronically, hydraulically and/or pneumatically.

In a further embodiment, the control may initially travel the compressed air cleaning arrangement along the outer periphery of the workpiece in a first direction at a first speed, and for example completely past it, and thereupon back in the opposite direction again at a second, slower speed, for example. In this respect, compressed air may only blown out on the movement in one direction, for example on the downward movement of the compressed air cleaning arrangement. The control may in this respect take place electronically, hydraulically and/or pneumatically.

The pressure of the compressed air supply or the travel speed may furthermore, above all on the cleaning of the workpiece, be varied and/or regulated in dependence on the position of the blowing nozzles to improve the cleaning effect with workpieces having different bore diameters and/or outer diameters. In this respect, a higher pressure or a slower travel speed may. be used e.g., when the bore is larger or the outer diameter is smaller.

The control may in this respect be configured such that it actuates the compressed air cleaning arrangement while the workpiece rotates in the workpiece spindle and/or after the centrifuging process has ended. In a possible embodiment, the compressed air cleaning arrangement may in this respect be moved in a first direction before or while the centrifuging process is carried out and in a second direction after the centrifuging process has already been carried out for a specific time period and/or has been ended. The control controls the centrifugal station and/or the compressed air cleaning arrangement automatically in this respect.

The compressed air cleaning arrangement in accordance with the present disclosure may be used, as shown above, within the framework of a centrifugal station in accordance with the present disclosure The compressed air cleaning arrangement in accordance with the present disclosure may, however, also be used separately from a centrifugal station in possible embodiment of the present disclosure or independently of a centrifugal station to clean geared workpieces from machining fluid.

The present disclosure therefore furthermore comprises a compressed air cleaning arrangement for the removal of a machining fluid from geared workpieces, wherein the compressed air cleaning arrangement removes machining fluid adhering in a region of the workpiece by blowing with compressed air. The compressed air cleaning arrangement may in, for example, remove machining fluid adhering to an inwardly disposed region of the workpiece and/or adhering to an outwardly disposed region of the workpiece by blowing with compressed air.

The compressed air cleaning arrangement is in this respect may be configured as was already shown in more detail above.

The compressed air cleaning arrangement in accordance with the present disclosure may, for example, be configured as a compressed air lance in a first embodiment. In this respect, the compressed air lance is, for example, used for cleaning a bore of a workpiece.

The compressed air cleaning arrangement may in this respect comprise a bar in whose head region a compressed air outlet is arranged which may be in communication with a compressed air source through a longitudinal bore of the bar.

The compressed air outlet of the compressed air cleaning arrangement in this respect conducts the compressed air flow from a head region of the compressed air cleaning arrangement obliquely to the rear, for which purpose an obliquely rearwardly orientated compressed air passage leads to the compressed air outlet in the interior of the head region.

The compressed air cleaning arrangement may in this respect have a rod part and a head part, with the compressed air being supplied through a longitudinal bore of the rod part and being conducted to the compressed air outlet through a region remaining free between the rod part and the head part.

The compressed air cleaning arrangement in accordance with the present disclosure is configured in a second embodiment as an outer periphery cleaner which may be used for cleaning the outer periphery of the workpiece with compressed air.

The outer periphery cleaner may have a compressed air outlet which extends in the form of one or more nozzles about a central cleaning region. The workpiece may be arranged in the central cleaning region such that its outer periphery is blown onto and cleaned by compressed air which flows from the compressed air outlet.

The compressed air outlet of the outer periphery cleaner may, for example, be a ring nozzle. Alternatively, however, a plurality of punctiform or linear nozzles may also be arranged in ring form about the central cleaning region.

The air outlet and the one or more nozzles may be obliquely inwardly directed, for example. In this respect, the air flows to the plane of the air outlet and/or to the longitudinal axis of the workpiece at an angle between 10° and 80° in one example, and between 20° and 70° in another example. The machining fluid is hereby moved by the air flow in an axial direction on the outer periphery of the workpiece.

The compressed air cleaning arrangement may in this respect be traveled into a bore of the workpiece and/or along the outer periphery of the workpiece.

The compressed air cleaning arrangement in this respect has a travel arrangement by which a compressed air outlet of the compressed air cleaning arrangement may be traveled with respect to the workpiece. In this respect, the compressed air cleaning arrangement and the compressed air lance and/or the outer periphery cleaner may be traveled.

The travel arrangement may in this respect engage at a rear region of the compressed air cleaning arrangement and of the compressed air lance and may move it in the longitudinal direction. A guide for the compressed air cleaning arrangement may furthermore be provided.

The compressed air cleaning arrangement in this respect may have a control for actuating the compressed air cleaning arrangement and/or for traveling the compressed air cleaning arrangement.

The control may be configured in an embodiment such that the compressed air cleaning arrangement first travels into the bore of the workpiece at a first speed, and completely travels through it for example, and thereupon travels out again at a second speed, for example a slow speed. In this respect, compressed air may be only blown out on the movement in one direction, for example on the downward movement of the compressed air cleaning arrangement. In this respect, compressed air may be only blown out on the moving out.

In a further embodiment, the control may initially travel the compressed air cleaning arrangement along the outer periphery of the workpiece in a first direction at a first speed, for example completely past it, and thereupon back in the opposite direction again at a second speed, such as a slower speed. In this respect, compressed air may be only blown out on the movement in one direction, for example on the downward movement of the compressed air cleaning arrangement.

The pressure of the compressed air supply or the travel speed may furthermore, above all on the cleaning of the workpiece, be varied and/or regulated in dependence on the position of the blowing nozzles to improve the cleaning effect with workpieces having different bore diameters and/or outer diameters. In this respect, a higher pressure or a slower travel speed may be used e.g., from the moment when the bore is larger or the outer diameter is smaller.

If the compressed air cleaning arrangement is not used in a centrifugal station as was shown above, it may be combined with a holding arrangement for the workpiece. The holding arrangement may, for example, be a gripper which holds the workpiece, for example, at its outer periphery and/or at its end edges and/or at a shaft bore. The compressed air cleaning arrangement may then be used to liberate the inwardly disposed region of the workpiece, for example an internal bore, from a machining fluid and/or to liberate an outwardly disposed region of the workpiece, such as the outer periphery, from a machining fluid.

The present disclosure furthermore comprises a cleaning station having at least one compressed air cleaning arrangement, for example two compressed air cleaning arrangements, as were described above. The cleaning station may, for example, may comprise two different compressed air cleaning arrangements and/or two compressed air cleaning arrangements for cleaning different regions of the workpiece, for example a compressed air lance and an outer periphery cleaner. The two compressed air cleaning arrangements may be traveled independently of one another. In another embodiment, however, both compressed air cleaning arrangements may also be travelable by a common travel arrangement.

The outer contour may in this respect be liberated from machining fluid by a centrifuge station and/or by the compressed air cleaning arrangement. The centrifugal station may, however, be provided separately from the compressed air cleaning arrangement and/or from the cleaning station and may in this respect be arranged before or after the compressed air cleaning arrangement. The compressed air cleaning arrangement and/or cleaning station may, for example, clean a workpiece while it is gripped by a transfer device.

The present disclosure furthermore comprises a gear-cutting machine having a centrifugal station such as was described above and/or having a compressed air cleaning arrangement such as likewise described above and/or having a cleaning station such as was described above. The gear-cutting machine serves the hard fine machining of pre-geared workpieces, for example. The gear-cutting machine may, for example, be a grinding machine.

The gear-cutting machine comprises a main machining station on which the workpieces are gear cut, for example fine machined, and in particular ground. Further, a transport arrangement may be provided via which the workpieces may be transported from the main machining station to the centrifugal station and/or to the compressed air cleaning arrangement and/or to the cleaning station. It may be, for example, a transfer device, such as a ring transfer device.

The present disclosure comprises a method for machining a workpiece comprising gear-cutting the workpiece, and removing machining fluid adhering in a region of the workpiece by blowing with compressed air.

Machining fluid adhering to an inwardly disposed region of the workpiece and/or adhering to an outwardly disposed region of the workpiece may, for example, be removed by blowing with compressed air.

The method in accordance with the present disclosure may, for example, be used to liberate bores of the workpiece, such as a shaft bore of the workpiece, from machining fluid and/or to liberate the outer periphery of a workpiece from machining fluid.

The method in accordance with the present disclosure in this respect furthermore comprises the step of removing machining fluid adhering to the workpiece by a centrifuging process in which the workpiece rotates. The workpiece is in this respect centrifuged at a speed between 500 and 5000 revolutions per minute.

The step of removing machining fluid with compressed air and the step of centrifuging may take place simultaneously in this respect. It is alternatively also possible, however, to carry out one of the two steps first and the other step only afterward.

In this respect, both steps may be carried out at the same station. Alternatively, the workpiece is transported from a station at which the first cleaning step is carried out to a further station at which the further cleaning step is carried out.

The method in accordance with the present disclosure in this respect takes place using a centrifugal station and/or a compressed air cleaning arrangement and/or a cleaning station and/or a gear-cutting machine such as were respectively shown above.

The present disclosure may be used to liberate bores which extend along the longitudinal axis of the workpiece from machining fluid, for example. However, transverse bores which branch off from such a longitudinal bore may hereby likewise optionally also be cleaned. The present disclosure may furthermore be used for cleaning the outer periphery of a workpiece.

A freedom from drips of the workpiece lasting for a time period of at least 10 minutes in one example, and of at least 30 minutes in another example, may be achieved by the cleaning in accordance with the present disclosure.

The present disclosure will now be presented in more detail with reference to embodiments and to drawings.

### BRIEF DESCRIPTION OF THE FIGURES

FIG. 1 shows an embodiment of a centrifugal station in accordance with the present disclosure with a first embodiment of a compressed air cleaning arrangement in accordance with the present disclosure in a side view.

FIG. 2 shows a detail view of the view shown in FIG. 1 which shows the workpiece spindle of the centrifugal station and the compressed air cleaning arrangement.

FIG. 3 shows a further detail view of the view shown in FIG. 1 which shows the lower workpiece mount of the workpiece spindle and the compressed air cleaning arrangement.

FIG. 4 shows a detail view of the workpiece clamped in the workpiece spindle in FIG. 1, with the compressed air cleaning arrangement passing through it.

FIG. 5 shows a detail view of the upper workpiece mount of the workpiece spindle and of the head region of the compressed air cleaning arrangement.

FIG. 6 shows a further detail view of the upper workpiece spindle and of the head region of the compressed air cleaning arrangement.

FIG. 7 shows a detail view of the head region of the compressed air cleaning arrangement.

FIG. 8 shows three representations which show the course of a cleaning method in accordance with the present disclosure.

FIG. 9 shows four representations which show the course of a cleaning method in accordance with the present disclosure with an alternative embodiment of the compressed air cleaning arrangement in accordance with the present disclosure which is adapted to a longer workpiece with a narrower inner diameter.

FIG. 10 shows three views which show the course of a cleaning method in accordance with the present disclosure in a further alternative embodiment of the compressed air cleaning arrangement which is adapted to a workpiece with a larger inner diameter.

FIG. 11 shows an embodiment of a centrifugal station in accordance with the present disclosure in which a second embodiment of a compressed air cleaning arrangement in accordance with the present disclosure is additionally provided in a side view.

FIG. 12 shows an enlarged representation of the two compressed air cleaning arrangements used in the embodiment in FIG. 11.

FIG. 13 shows the nozzle body of the second embodiment of a cleaning station in accordance with the present disclosure in two end positions of the travel path.

FIG. 14A shows an embodiment of a centrifugal station in accordance with the present disclosure with the second embodiment of a compressed air cleaning arrangement in accordance with the present disclosure in a maximum traveled-out position of the travel arrangement.

FIG. 14B shows the embodiment shown in FIG. 14A in a middle traveled-out position of the travel arrangement.

FIG. 14C shows the embodiment shown in FIGS. 14A and 14B in a minimal traveled-out position of the travel arrangement.

FIG. 15 shows an embodiment of a centrifugal station in accordance with the present disclosure with the second embodiment of a compressed air cleaning arrangement in accordance with the present disclosure in a further variant.

FIG. 16 shows an enlarged representation of the nozzle body of the compressed air cleaning arrangement shown in FIG. 15.

FIG. 17 shows a method flowchart for machining a workpiece.

### DETAILED DESCRIPTION

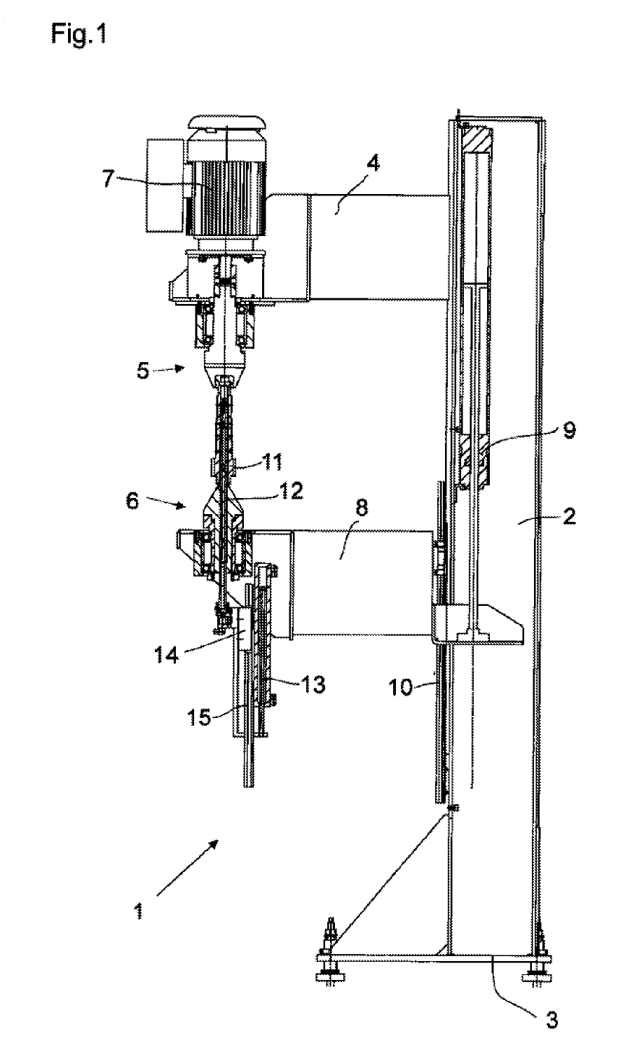

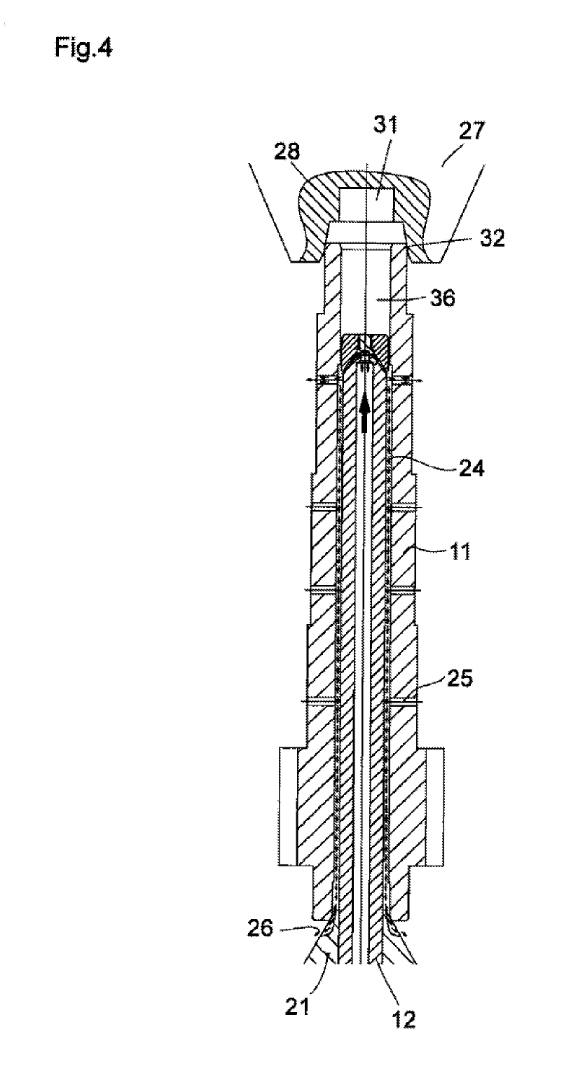

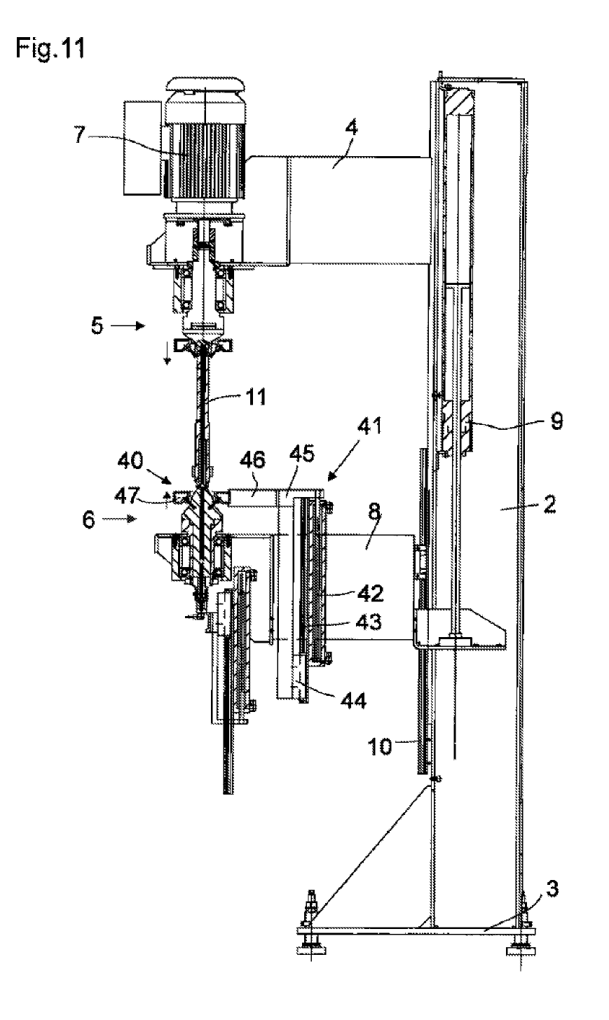

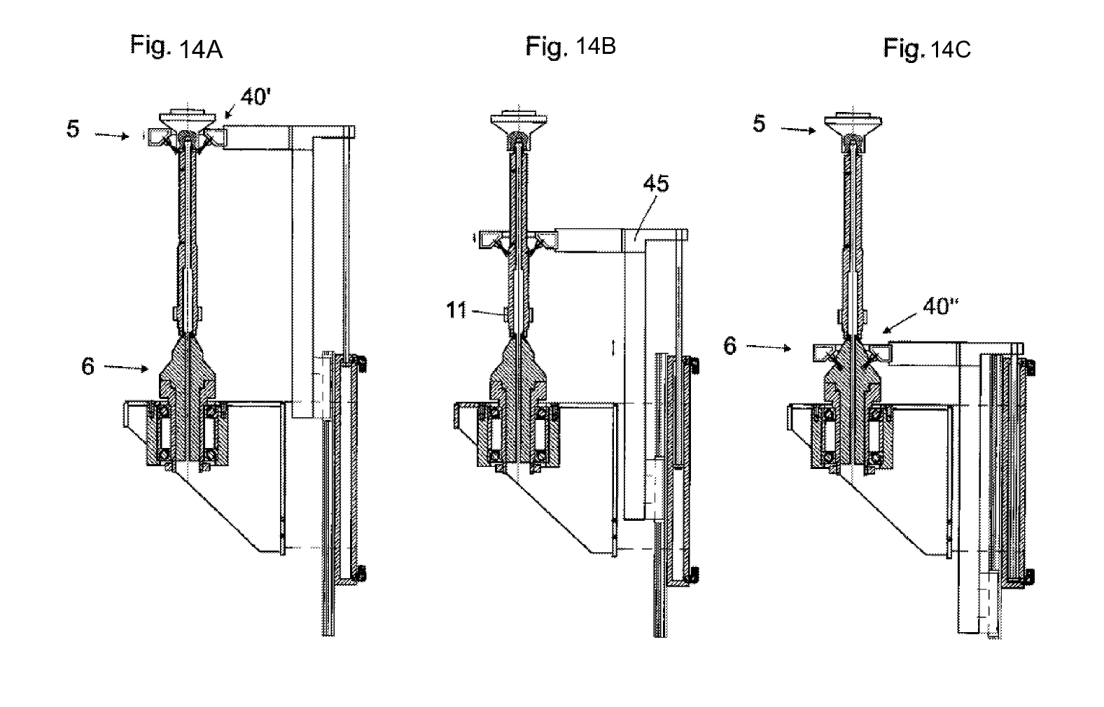

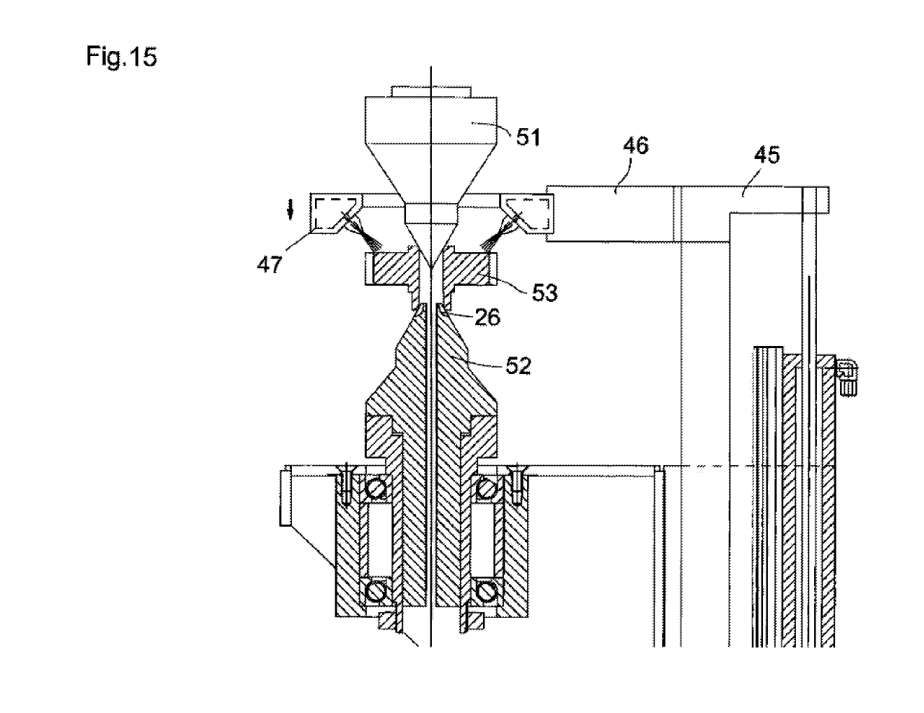

An embodiment of a centrifugal station in accordance with the present disclosure is shown in FIGS. 1 to 16, wherein a first embodiment of a compressed air cleaning arrangement in accordance with the present disclosure is integrated into the centrifugal station in FIGS. 1 to 10; a second embodiment of a compressed air cleaning arrangement in accordance with the present disclosure is additionally integrated in FIGS. 11 to 13; and only the second embodiment of a compressed air cleaning arrangement in accordance with the present disclosure is integrated in FIGS. 14 to 16.

The centrifugal station is in this respect a stand-alone solution which may be arranged via the stand 2 on its own foundation 3. The independent arrangement of the centrifugal station with respect to a gear-cutting machine prevents the transfer of vibrations from the centrifugal station to the gear-cutting machine.

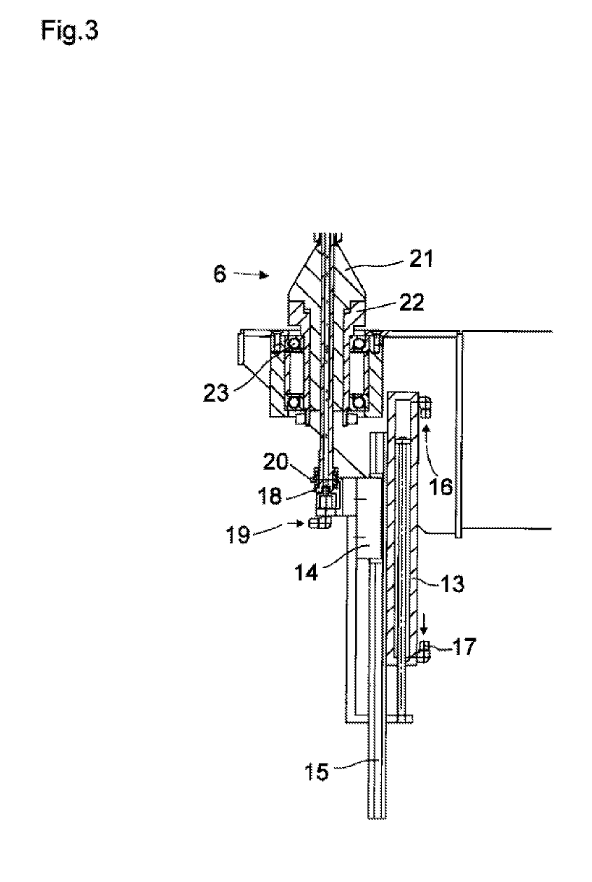

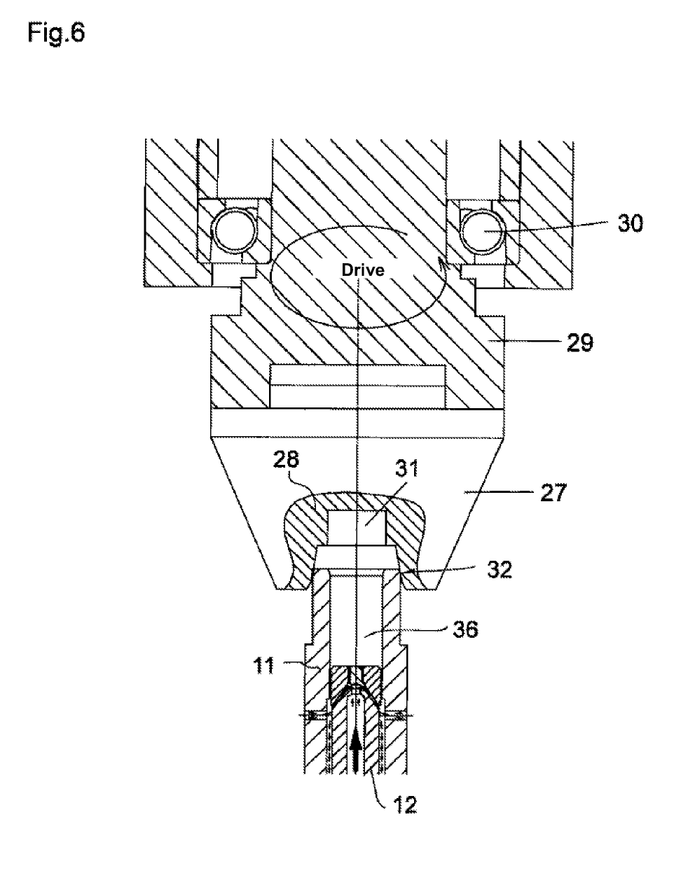

The centrifugal station has a workpiece spindle having an upper workpiece mount 5 and a lower workpiece mount 6 between which a workpiece 11 may be clamped. The upper workpiece spindle 5 may be driven via the drive 7. As may be recognized more clearly in FIGS. 3 and 6, the workpiece spindles 5 and 6 are rotatably supported via bearings 30 and 23 at an upper spindle carrier 4 or at a lower spindle carrier 8. The upper spindle carrier 4 is in this respect fixedly connected to the stand 2 and is thus not vertically adjustable. The lower spindle carrier 8, in contrast, is arranged movable in the vertical direction at the stand 2. For this purpose, the lower spindle carrier 8 is arranged linearly displaceable at a guide 10 of the stand 2 and may be adjusted via an actuator 9, a hydraulic cylinder in the embodiment. A reverse arrangement of the vertical adjustment in which the upper spindle carrier moves downwardly toward the fixed-position lower spindle carrier is likewise conceivable.

A workpiece may be received in the workpiece spindle such that the lower workpiece mount 6 is moved via the lower spindle carrier 8 to a workpiece 11 gripped by a gripper, raises it and then moves it toward the upper workpiece mount 5. The workpiece 11 is in this respect in friction engagement with the upper workpiece mount 5 and may be hereby set into rotation via the drive 7.

The workpiece 11 is in this respect advantageously rotated at a speed between 500 revolutions per minute and 5000 revolutions per minute in centrifuging operation to remove cooling lubricant residues adhering to the outer periphery of the workpiece.

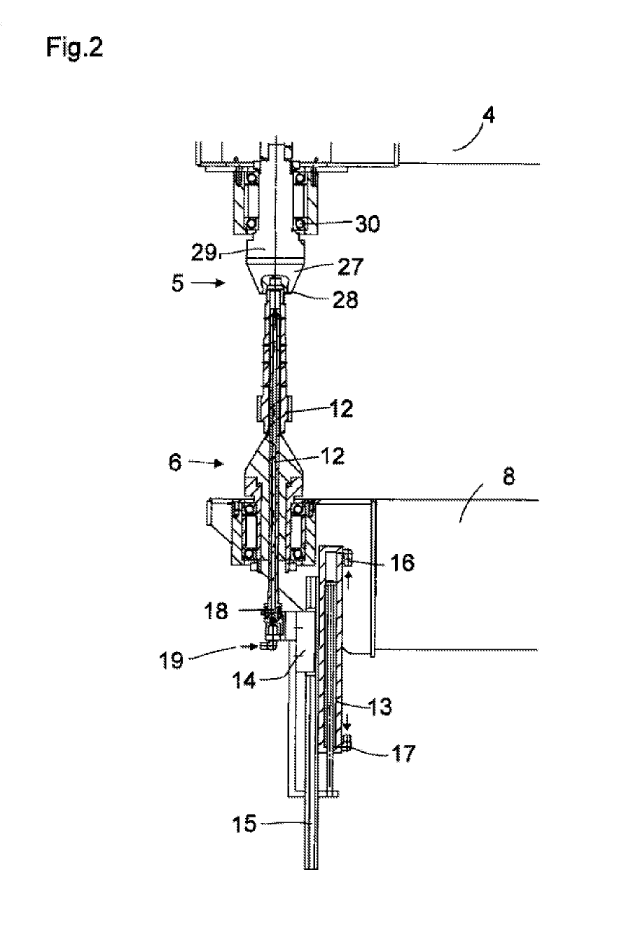

In the first embodiment shown in FIGS. 1 to 10, the centrifugal station furthermore has a compressed air cleaning arrangement 12 in accordance with the present disclosure which is likewise used to liberate the shaft bore of the workpiece 11 from cooling lubricant. As may be recognized in FIG. 2, the compressed air cleaning arrangement 12 is in this respect a compressed air lance which may be introduced into the shaft bore of the workpiece 11 and which removes the cooling lubricant present there by blowing with compressed air.

The compressed air lance 12 may in this respect be moved into and out of the shaft bore via a travel arrangement. For this purpose, a rearward region of the compressed air 12 is fastened to a slide 14 which is linearly displaceable at a guide 15. To displace the slide 14, it is connected to an actuator 13, a hydraulic cylinder in the present case, and may be linearly displaced along the guide 15 via it. The travel direction of the slide is in this respect in parallel with the longitudinal extent of the compressed air lance 12. The hydraulic cylinder has hydraulic chambers which may be supplied with hydraulic fluid via the hydraulic connectors 16 and 17 to actuate the travel arrangement.

The compressed air lance 12 is in this respect arranged in the region of the lower workpiece mount 6 of the workpiece spindle and passes centrally through it. The compressed air lance may hereby be moved into the shaft bore of the workpiece 11 while it is clamped on the workpiece spindle. The compressed air lance 12 is in this respect longitudinally displaceably supported in the lower workpiece mount 6. The compressed air lance is moreover not in the way on the loading of the lower workpiece mount 6 due to this arrangement. The travel arrangement with the guide 15 is fastened to the lower spindle carrier 8 and may thus displace the compressed air lance 12 relative to the lower spindle carrier 8 and thus to the lower workpiece mount 6.

The compressed air lance 12 may in this respect co-rotate with the lower workpiece spindle 6. For this purpose, the compressed air lance 12 is rotatably fasted in its rear region to the slide 14 of the travel arrangement. The cleaning may hereby take place by the compressed air cleaning arrangement while the workpiece is simultaneously rotated in the workpiece spindle, i.e. during the centrifuging process.

The compressed air lance 12 is in this respect of tubular design and has in its interior a compressed air passage 34 which is in communication with a compressed air supply 19 not shown in any more detail. For this purpose, a rotary union 18 is provided in the region of the connection of the compressed air lance 12 with the travel arrangement and the compressed air passage 34 is in communication via it in the interior of the tubular compressed air lance 12 with the compressed air supply.

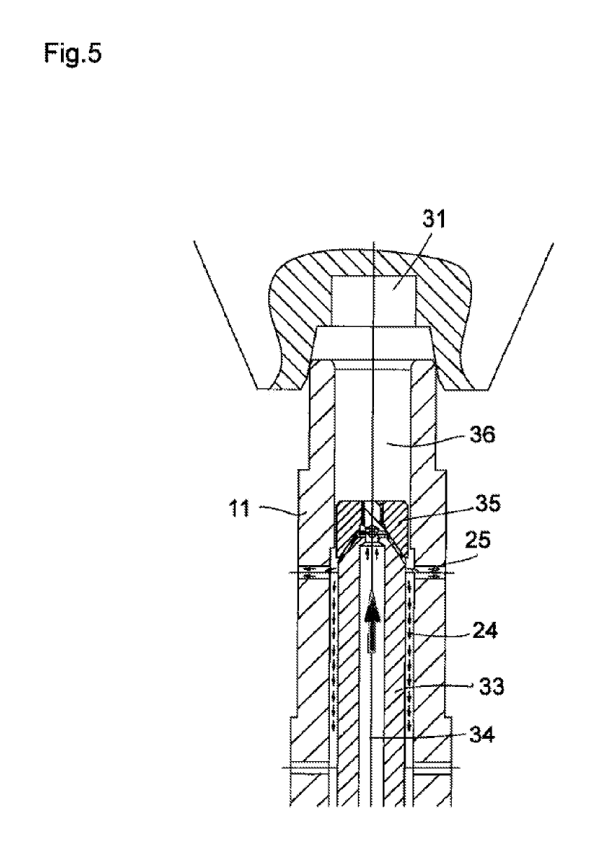

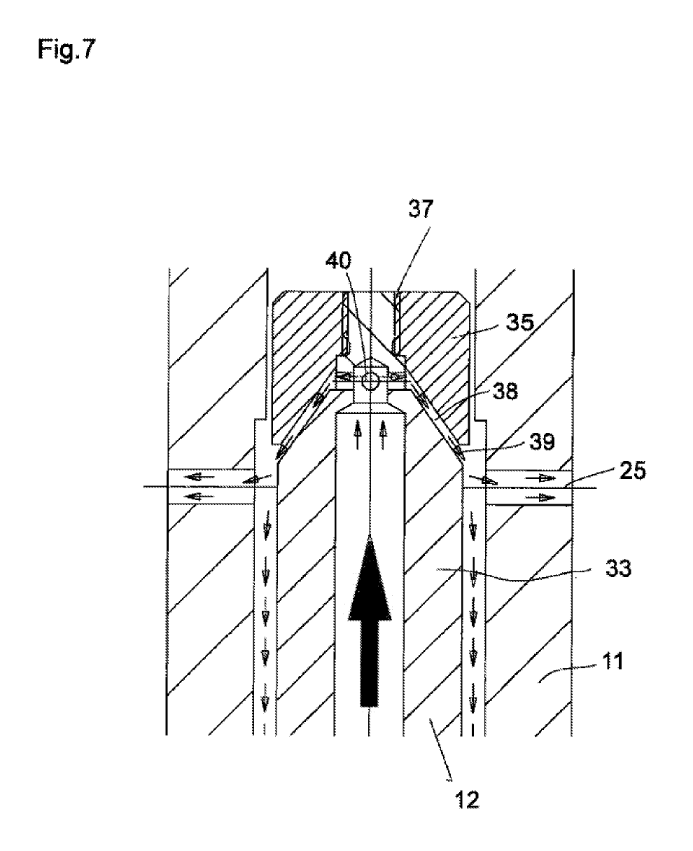

As shown in more detail in FIG. 5 and FIG. 7, the compressed air which is conducted via the compressed air passage 34 through the compressed air lance is conducted laterally outwardly in its head region. For this purpose, the compressed air lance has a peripherally arranged compressed air outlet 39 in its head region.

The compressed air is in this respect obliquely rearwardly blown out of the compressed air outlet 39. For this purpose, the compressed air outlet 39 is in communication with the compressed air supply via a compressed air passage 38 extending obliquely rearwardly in the interior of the compressed air lance.

The diversion of the compressed air flow takes place in this respect in the embodiment via a head part 35 which is fastened to the end face of the tube part 33 and is, for example, screwed on via a thread 37. The outer contour of the end face of the tube part 33 and the inner contour of the head part 35 are in this respect each of conical design and thus produce the obliquely rearwardly directed compressed air passage 38. The connection between the compressed air passage 34 in the interior of the tubular part 33 and the compressed air passage 38 takes place via bores 40 in this respect, for example.

The head part 35 in this respect has a larger diameter than the tubular part 33 to conduct the compressed air downwardly or rearwardly.

The compressed air flowing out of the compressed air outlet 39 at the peripheral side now drives the cooling lubricant adhering in the region of the shaft bore 36 downwardly along the gap 24 between the compressed air lance and the inner wall of the shaft bore 36 and to the outside via transverse bores 25 which the workpiece has.

To allow an outflow of the cooling lubricant and of the compressed air in a lower region of the workpiece, the workpiece is seated on a support part 21 of the lower workpiece mount which has grooves 26 at its outer periphery. The support part 21 in this respect forms a centering cone on which the end-face inner contour of the workpiece is seated. Only the main quantity of the compressed air may here escape through the cut-outs 26 and in so doing also drives the cooling lubricant out of the bore.

The upper workpiece mount 5 in contrast has a mount part 27 which connects the drive 7 with frictional engagement to the upper edge 32 of the workpiece. The mount part 27 in this respect has a region 28 of a material with a high coefficient of friction. This mount part 27 in this respect has a mount into which the upper outer contour of the workpiece may be pushed. Furthermore, a hollow space 31 is provided above the shaft bore 36 in the mount part 27, said hollow space extending the shaft bore 36 and having a diameter which is at least as large as that of the shaft bore. The compressed air lance 12 may hereby be completely pushed through the shaft bore 36, and indeed so far that the compressed air outlet 39 is arranged above the upper end face of the workpiece 12. The shaft bore may hereby be completely cleaned from top to bottom. In the completely traveled-out position, the head region, such as the head part 35 of the compressed air lance for example, may be arranged in the hollow space 31 in this respect.

The upper mount part 27 in this respect forms a swappable part which may be adapted to the respective workpiece. It is in this respect connected via a quick connector 55 to a support element 29 which rotatably supports the upper workpiece mount 5 via the bearings 30.

In the same way, the lower support part 31 forms a swappable part which may be connected to a support part 22 via a quick connector. The support part 22 in this respect rotatably supports the lower workpiece mount 6 at the lower spindle carrier 8 via the bearings 23.

The compressed air lance 12 also forms a swappable part which may respectively be swapped together with the lower support part 21 and may hereby be adapted to the respective workpiece to be cleaned. The compressed air lance is in this respect designed in each case so that only a small gap remains between the outer periphery of the compressed air lance and the smallest inner diameter of the shaft bore.

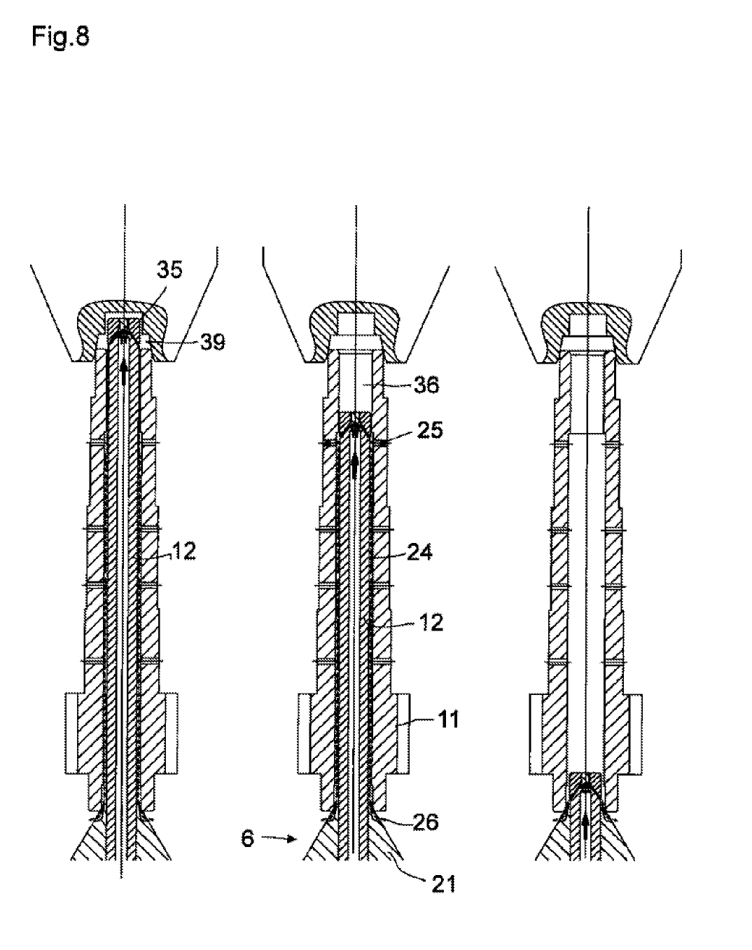

As shown in FIG. 8, the compressed air lance 12 is first quickly conducted completely through the shaft bore of the workpiece at the start of the cleaning process. As already described above, the compressed air outlet 39 in this respect comes to lie above the upper end edge of the workpiece. Compressed air is thereupon blown out and the compressed air lance is moved back again more slowly. As may be clearly recognized in FIG. 8, in this respect the cooling lubricant flows downwardly along the gap 24 between the compressed air lance 12 and the inner contour of the shaft bore 36 and escapes either through transverse bores 25 or via the grooves 26 of the lower support part. The compressed air lance is in this respect traveled so far downwardly that the compressed air outlet 39 is located in that region in which the workpiece is seated on the lower support part 21. The cooling lubricant is hereby completely removed from the shaft bore 36.

The cleaning process by the compressed air lance in accordance with the present disclosure in this respect takes place during the centrifuging process. In this respect, the centrifugal station has a control which coordinates the movement of the compressed air lance 12, the blowing out of the compressed air and the rotation of the workpiece spindle by the drive 7.

The workpiece 11 may be gripped via a gripper after the removal of the cooling lubricant. The lower workpiece mount 6 thereupon travels downwardly via the travel arrangement so that the workpiece may be removed.

The present disclosure may in this respect be used in all kinds of geared workpiece. It may in this respect be used with rotationally symmetrical workpieces having an outer and/or inner gear, for example. It may in this respect be used with rotationally symmetrical workpieces having a central shaft bore in another example.

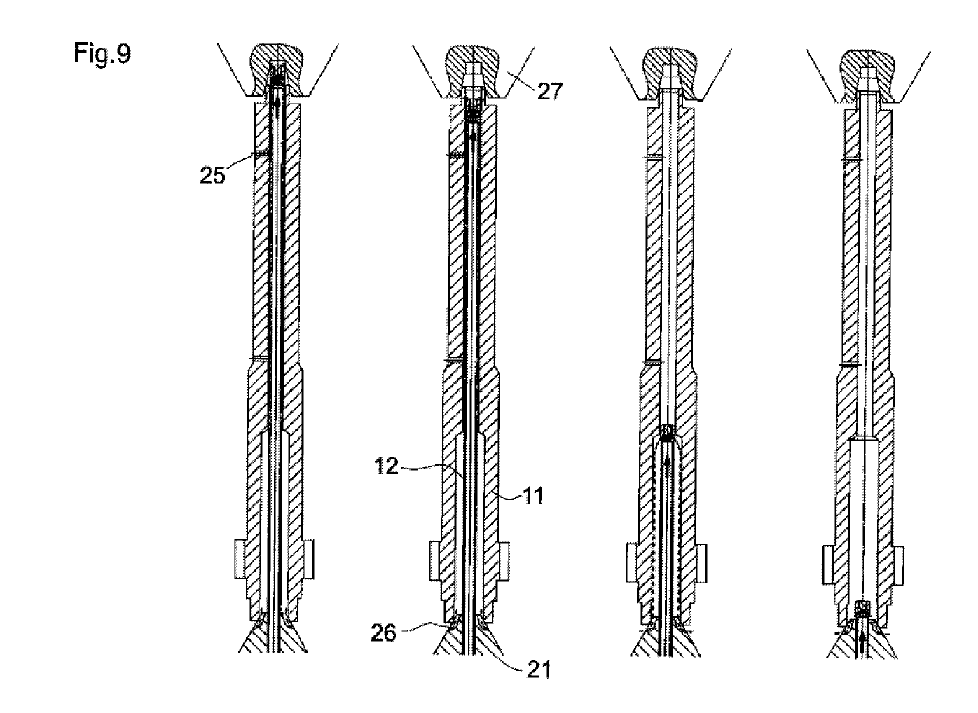

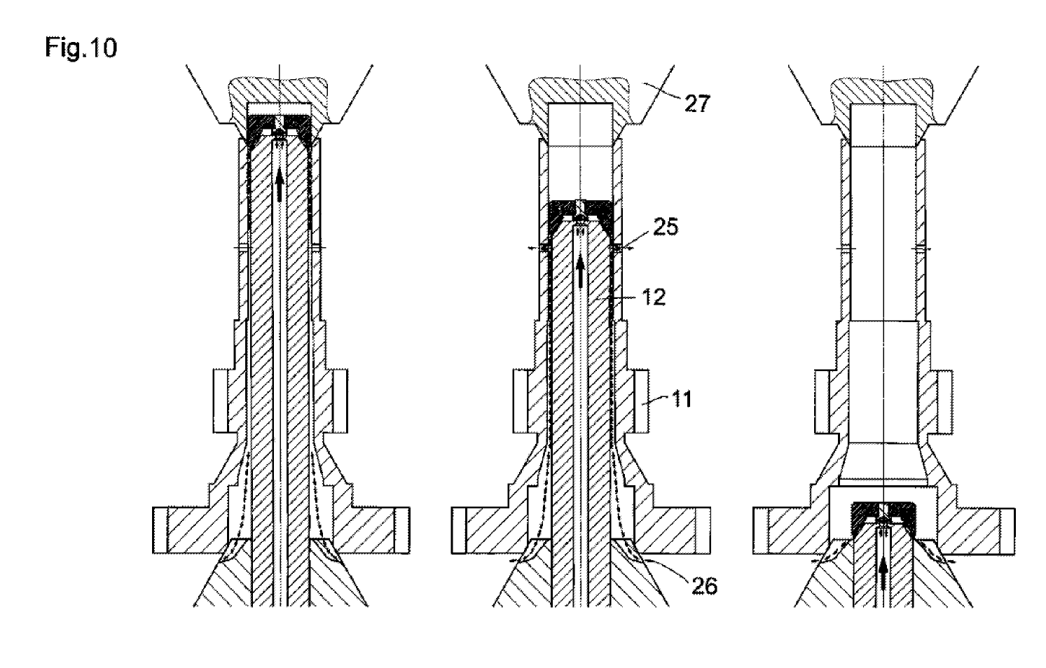

Special advantages in this respect in result with shaft-like workpieces, above all those with a bore, e.g., with workpieces whose longitudinal extent is greater than their diameter. In this respect, a workpiece is shown in FIG. 9 which is longer than the workpiece shown in FIGS. 1 to 8 and which has a narrower shaft bore. The adaptation to such a workpiece takes place by a corresponding swapping of the lower support part 21 together with the compressed air lance 12 and of the upper mount part 27. The adaptation to the workpiece shown in FIG. 10 which has a wider shaft bore and which is shorter than the other workpieces takes place in the same way.

In the previously shown embodiments, the compressed air cleaning arrangement was in this respect used to liberate an inwardly disposed region of the workpiece, for example a shaft bore of the workpiece from adhering machining fluid by blowing with compressed air.

A compressed air cleaning arrangement in accordance with the present disclosure may, however, also be used to remove machining fluid adhering to an outwardly disposed region of the workpiece by blowing with compressed air, for example to remove machining fluid adhering to an outer periphery of the workpiece by blowing with compressed air. The centrifugal station in accordance with the present disclosure may have a correspondingly designed compressed air cleaning arrangement for this purpose.

An embodiment of the centrifugal station in accordance with the present disclosure is now shown in FIG. 11 which has, in addition to the first embodiment of a compressed air cleaning arrangement for cleaning an inwardly disposed region of the workpiece described with respect to FIGS. 1 to 7, a second embodiment of a compressed air cleaning arrangement in accordance with the present disclosure for cleaning an outwardly disposed region. The centrifugal station as such is in this respect of exactly the same design as was already described above.

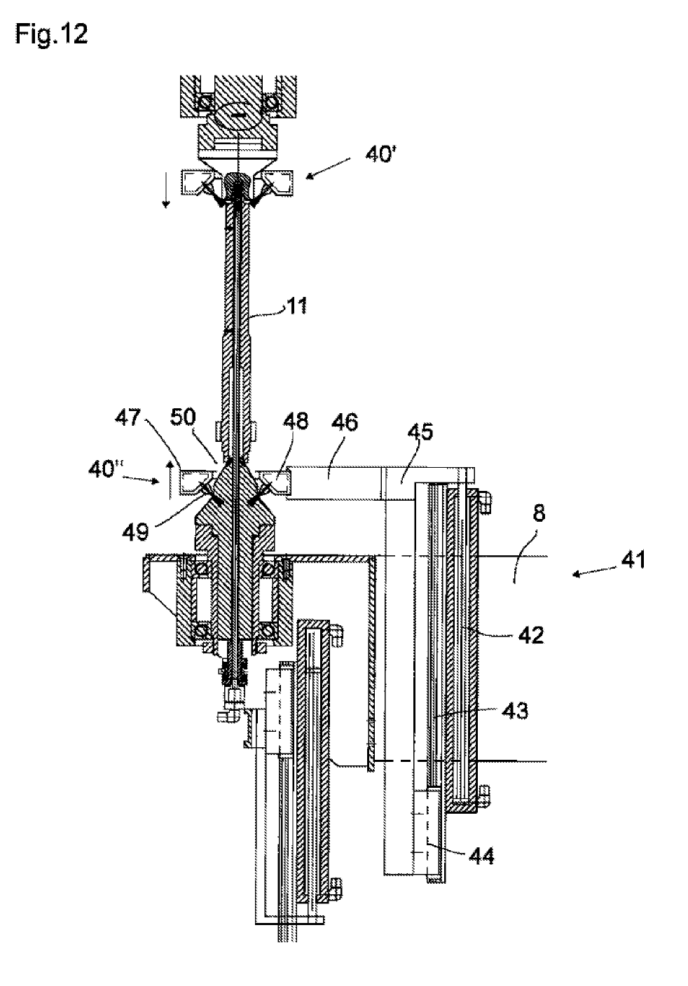

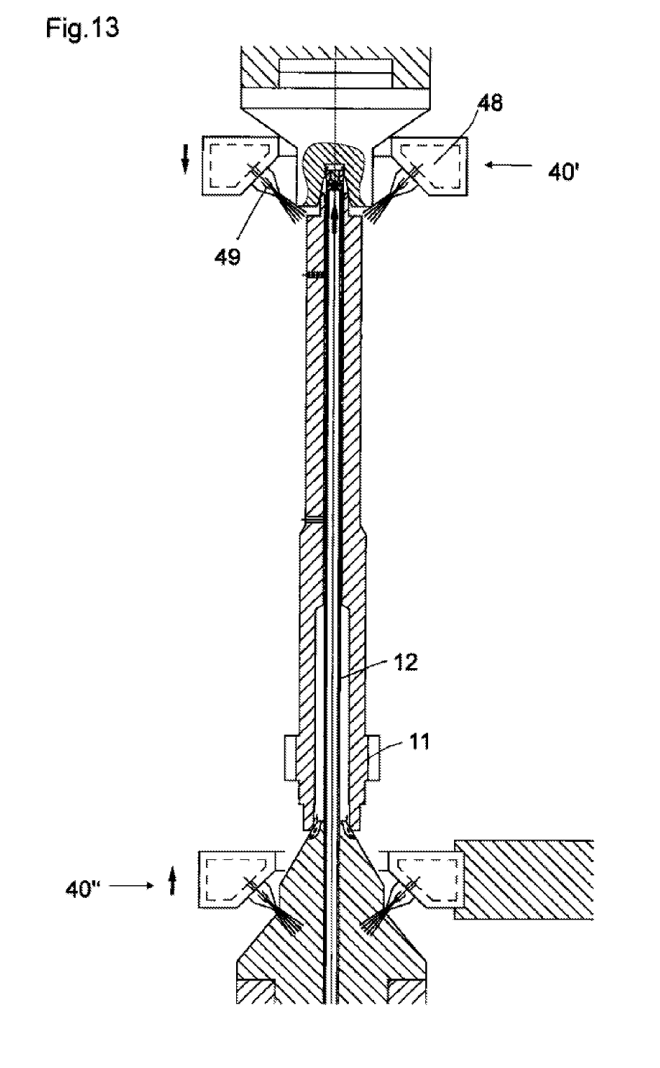

The second, additionally provided embodiment of a compressed air cleaning arrangement is in this respect configured as an outer periphery cleaner 40. As may also be recognized from FIGS. 12 and 13, the outer periphery cleaner in this respect has a compressed air outlet having one or more nozzles 49 which surround a central free space 50 and blow out compressed air obliquely inwardly. The free space 50 in this respect forms a cleaning region in which a workpiece may be arranged to be cleaned.

In the embodiment, in this respect a nozzle body 47 is provided in the form of a hollow ring body at whose inner periphery a plurality of nozzles 49 or one ring nozzle 49 are provided. The blow-out direction in this respect amounts to around 45° to the longitudinal axis of the workpiece or to the direction of travel of the outer periphery cleaner. The nozzle body 47 has a ring-shaped hollow space 48 with which the nozzle or nozzles 49 are in communication and which supplies them with compressed air. The hollow space 48 is in this respect connected to a compressed air source by a compressed air passage not shown in more detail.

The outer periphery cleaner 40 is travelable in the longitudinal direction of the workpiece. A travel arrangement 41 is provided for this purpose to which the nozzle body 47 is fastened. The travel arrangement comprises a guide 43 at which a travel element 45 is longitudinally displaceably supported via a slide 44. The travel element 45 is in this respect moved via a cylinder 42. In the embodiment, it may in this respect be a hydraulic cylinder or a pneumatic cylinder. The direction of movement of the travel arrangement such as that of the guide 43 is in this respect in parallel with the axis of rotation of the workpiece spindle and thus in parallel with the longitudinal axis of the workpiece. The nozzle body 47 is in this respect connected to the travel element 45 via a holding arm 46.

The travel arrangement 41 is arranged at the lower spindle carrier 8 and is traveled with it.

In FIGS. 12 to 14, the outer periphery cleaner 40 is in this respect shown in a position 40′ traveled upwardly by a maximum and in a position 40″ moved downwardly by a maximum. In the position 40′, the outer periphery cleaner and its nozzles are located above the upper end edge of the workpiece 11. In the maximum lower position 40″, the outer periphery cleaner 40 and the nozzle body 47, for example, are located completely beneath the lower edge of the workpiece 11.

The lower position 40″ in this respect represents the starting position of the outer periphery cleaner. It may adopt it when the workpieces are to be swapped. The outer periphery cleaner is then traveled into its maximum upper position 40′ for carrying out the cleaning. The outer periphery cleaner may thereupon traveled back down at a slower speed, wherein compressed air is blown out and cleans the outer periphery of the workpiece 11. The speed downwardly and the pressure may additionally be regulated in dependence on the bore diameter or on the outer periphery or on the travel position in order further to improve the cleaning result. In contrast, no air is blown out on the faster moving up.

The cleaning of the outer periphery by compressed air takes place after or during the carrying out of the centrifuging process and in so doing provides a still better cleaning of the outer periphery. In this respect, the outer periphery cleaner may optionally be traveled into its maximum upper position 40′ before the centrifuging process in order not itself to be contaminated by machining fluid dripping down in the centrifuging process. The outer periphery cleaner may, however, optionally also be traveled into its maximum upper position during the centrifuging process or after the end of the centrifuging process.

The nozzle body 47 and/or the holding arm 46 is/are in this respect configured as a swappable part so that this embodiment of the compressed air cleaning arrangement may also be adapted to the respective workpiece to be cleaned. The same travel arrangement is, however, advantageously always used. The travel arrangement therefore has a travel path which is the same as or larger than the maximum spread of the workpiece mount. The same applies in another respect to the travel arrangement of the first embodiment of the cleaning arrangement.

In the embodiment shown in FIGS. 11 to 13, the two cleaning arrangements may be moved via respective separate travel arrangements, and may thus be controlled independently of one another, for cleaning the shaft bore and for cleaning the outer periphery. They are, however, moved in parallel with one another, by the machine control. In an alternative embodiment, however, both cleaning arrangements could also be travelable via a common travel arrangement.

Further embodiments of the present disclosure are shown in FIGS. 14 to 16 in which only one cleaning arrangement is provided for cleaning outwardly disposed regions of a workpiece. In the embodiment used in FIG. 14, it is in this respect the centrifugal station in accordance with the present disclosure such as is shown in FIGS. 11 to 13, with the first cleaning arrangement in the form of a compressed air lance used in FIGS. 1 to 7 being dispensed with, however. This is used, for example, when the workpieces do not have a bore. FIGS. 14A to 14C in this respect show three positions of the outer periphery cleaner during the cleaning process.

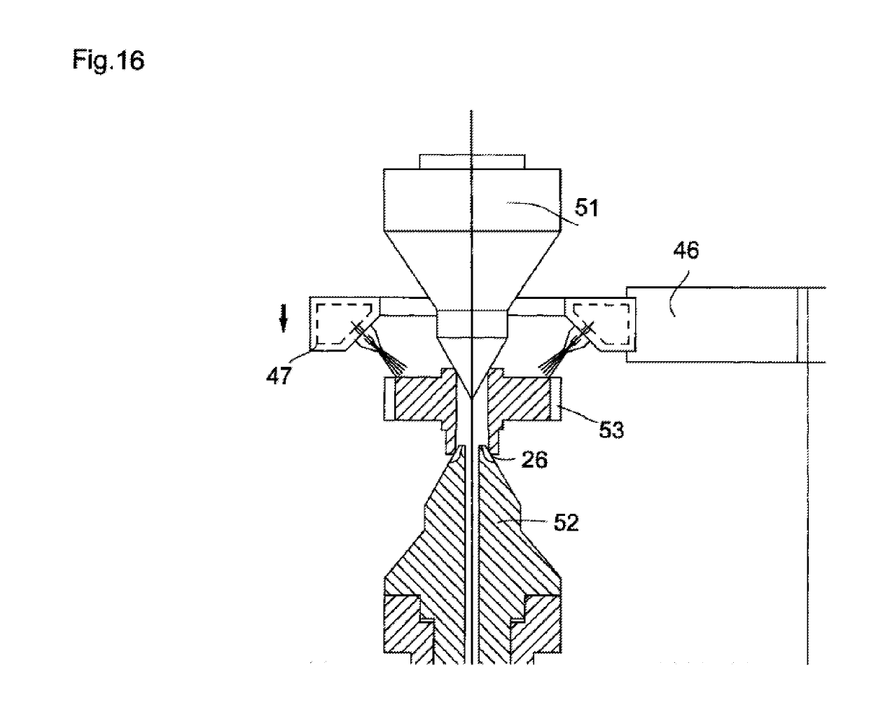

A further embodiment of a centrifugal station in accordance with the present disclosure is shown in FIGS. 16 and 16 which is used for cleaning a gear wheel. The gear wheel is in this respect clamped into the workpiece spindle via mount cones 51 and 52 in its shaft bore. No cleaning of the shaft bore by compressed air takes place here. In accordance with the present disclosure, an outer periphery cleaner is, however, provided such as is already used in the embodiments shown in FIGS. 12 to 15. Only the diameter of the nozzle body 47 was correspondingly adapted to the outer periphery of the gear wheel 53 here.

Even though the shaft bore is not cleaned by the compressed air cleaning arrangement here, cut-outs 26 are provided in the outer periphery of the mount cone 52 through which machining fluid may run off downwardly. The centrifuging process is sufficient for this due to the only small length of the shaft bore.

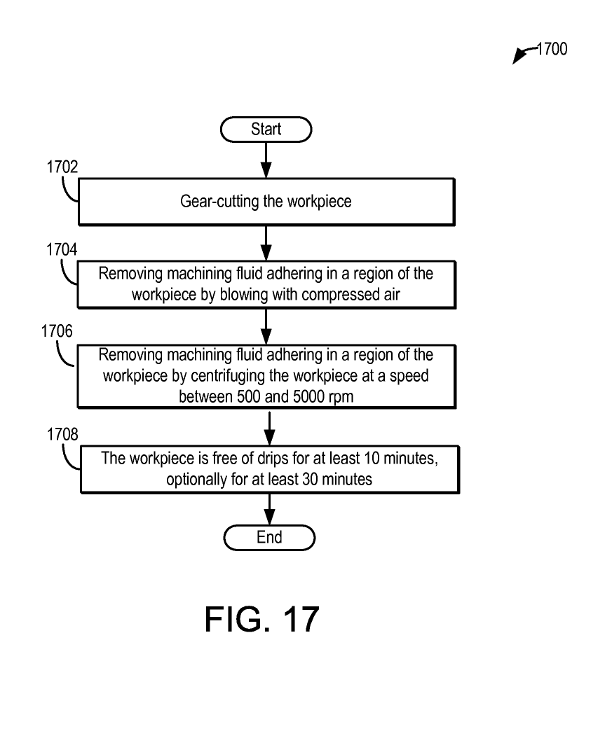

Turning now to FIG. 17, it shows a method flowchart for machining a workpiece, such as workpiece 11, for example. At 1702, the method begins by performing at least one gear-cutting step on the workpiece. The complete process of gear-cutting of the workpiece may include a plurality of gear-cutting steps, and at 1702 one, several or all of these gear-cutting steps may be performed. The step may be performed on a gear-cutting machine, such as a grinding machine, for example. Further, the gear-cutting machine may have a centrifugal station such as the centrifugal station of FIG. 1, and/or may have a compressed air cleaning arrangement such as compressed air cleaning arrangement 12, for example.

At 1704, the method includes removing machining fluid adhering in a region of the workpiece by blowing with compressed air. A compressed air cleaning arrangement, such as a compressed air lance, may be controlled by a machine control, for example, to provide a compressed air flow to the workpiece in order to remove machining fluid for a region inside the workpiece, for example. Further, there may be an outer periphery compressed air cleaning arrangement controlled by a machine control for removing the machining fluid from the outer periphery of the workpiece. Still further, a machine control may actuate the compressed air cleaning arrangements electronically, hydraulically and/or pneumatically.

At 1706, the method comprises removing machining fluid adhering in a region of the workpiece by centrifuging the workpiece at a speed between 500 and 5000 revolutions per minute. This action may be performed simultaneously to that of 1704, or the two actions may be performed asynchronously. A centrifugal station, which may comprise a workpiece spindle like workpiece spindle 5 and may be driven by a driver such as driver 7, may provide the centrifugal force that removes the machining fluid from the workpiece.

At 1708, the method has cleaned the workpieces such that no drops of machining fluid will fall down from the workpieces for at least 10 minutes, optionally for at least 30 minutes. This may be achieved by centrifuging and blowing compression air simultaneously, or in alternating actions, or in any order, or by blowing compression air.

The centrifuge station in accordance with the present disclosure may be integrated into a production line for manufacturing geared workpieces. In this respect, it may be part of a gear-cutting machine which may be, however, of multipart design so that the main machining station and the centrifugal station are statically separate from one another. In this respect, a workpiece machined on the main machining station is, for example, picked up via a transfer device or gripper and is transported to the centrifugal station, where the cooling lubricant used during the gear cutting process is removed. In a possible embodiment, the main processing station is a station for hard fine machining, for example for grinding, such as for gear grinding of gears.

The cleaning arrangement in accordance with the present disclosure is used as in the embodiments shown above as a part of a centrifugal station. This may be favorable with respect to the fact that the compressed air cleaning and the centrifuging may hereby take place simultaneously. The workpiece is furthermore hereby completely cleaned in one workstep and may then be gripped by a dry gripper.

In alternative embodiments of the present disclosure, the compressed air cleaning arrangement may, however, also be used separately or independently of a centrifugal station. The compressed air cleaning arrangement in accordance with the present disclosure may be conducted by a workpiece or past a workpiece which is held in a gripper, for example. Such a cleaning could in this respect take place before, after or instead of a centrifuging.

1. A centrifugal station for removing a machining fluid from workpieces, comprising a workpiece mount which is set into rotation by a drive to liberate a workpiece which is received in the workpiece mount from adhering machining fluid, wherein the centrifugal station has at least one compressed air cleaning arrangement which removes machining fluid adhering on a region of the workpiece by blowing with compressed air.

2. The centrifugal station in accordance with claim 1, wherein the compressed air cleaning arrangement is configured as a compressed air lance, wherein the compressed air lance is used for cleaning a bore of the workpiece.

3. The centrifugal station in accordance with claim 1, wherein the compressed air lance comprises a bar in whose head region a compressed air outlet is arranged which is in communication with a compressed air source through a longitudinal bore of the bar.

4. The centrifugal station in accordance with claim 1, wherein the compressed air cleaning arrangement is configured as an outer periphery cleaner which is used for cleaning the outer periphery of the workpiece with compressed air, wherein the outer periphery cleaner has a compressed air outlet which extends in the form of one or more nozzles about a central cleaning region.

5. The centrifugal station in accordance with claim 1, wherein the one or more nozzles are directed obliquely inwardly.

6. The centrifugal station in accordance with claim 1, comprising a travel arrangement by which a compressed air outlet of the compressed air cleaning arrangement travels with respect to the workpiece, and/or comprising a travel arrangement by which the compressed air cleaning arrangement, which is configured as a compressed air lance and/or an outer periphery cleaner, travels.

7. The centrifugal station in accordance with claim 1 comprising a first and a second compressed air cleaning arrangement, the first compressed air cleaning arrangement configured as a compressed air lance and the second compressed air cleaning arrangement configured as an outer periphery cleaner, wherein the two compressed air cleaning arrangements travel independently of one another, and/or wherein a control is provided via which the two compressed air cleaning arrangements travel in parallel.

8. The centrifugal station in accordance with claim 1, wherein the cleaning of the workpiece is carried out by the compressed air cleaning arrangement during the centrifuging and/or after the centrifuging of the workpiece, and/or wherein the compressed air cleaning arrangement is arranged at a workpiece mount of the workpiece spindle and/or passes through a workpiece mount of the workpiece spindle, and/or wherein the compressed air cleaning arrangement co-rotates with the workpiece mount of the workpiece spindle and is in communication with a compressed air source via a rotary union, and wherein the compressed air cleaning arrangement passes longitudinally displaceably through the workpiece mount, and/or wherein the oppositely disposed workpiece mount has a hollow space extending the wave bore into which a head of the compressed air cleaning arrangement can at least be partially traveled, and/or wherein the lower workpiece mount holds the workpiece so that machining fluid runs out of the wave bore of the workpiece, with the workpiece mount being a centering cone at whose outer periphery grooves are provided, and/or wherein the upper workpiece mount of the workpiece spindle sealingly terminates the wave bore, wherein the upper workpiece mount has an inner contour with which it is placed with frictional engagement on the outer periphery of the workpiece.

9. The centrifugal station in accordance with claim 1, wherein the compressed air outlet of the compressed air cleaning arrangement conducts the compressed air flow from a head region of the compressed air cleaning arrangement obliquely rearwardly, for which purpose an obliquely rearwardly directed compressed air passage leads to the compressed air outlet.

10. The centrifugal station in accordance with claim 1, wherein the compressed air cleaning arrangement has a rod part and a head part, wherein the compressed air is supplied through a longitudinal bore of the rod part and is conducted to the compressed air outlet through a region remaining free between the rod part and the head part, and wherein the head part and/or the compressed air cleaning arrangement and/or one or both workpiece supports is/are swappable parts.

11. The centrifugal station in accordance with claim 1, comprising a control for actuating the compressed air cleaning arrangement and/or for traveling the compressed air cleaning arrangement, wherein the control first moves the compressed air cleaning arrangement into the bore of the workpiece, and completely through it, at a first speed and thereupon moves it out again at a second, slower speed, and/or wherein the control first travels the compressed air cleaning arrangement along the outer periphery of the workpiece in a first direction at a first speed, and completely past it, and thereupon travels it back in the opposite direction again at a second, slower speed.

12. The centrifugal station in accordance with claim 11, wherein compressed air is only blown out on the moving out of the compressed air cleaning arrangement out of the bore, and/or wherein compressed air is only blown out on the movement of the compressed air cleaning arrangement in one direction.

13. The centrifugal station in accordance with claim 11, wherein the travel speed and/or the air pressure is regulated in dependence on the bore diameter, and/or wherein the travel speed and/or the air pressure is varied in dependence on the travel position, and/or wherein the control actuates the compressed air cleaning arrangement while the workpiece rotates in the workpiece spindle.

14. A compressed air cleaning arrangement for the removal of a machining fluid from geared workpieces, wherein the compressed air cleaning arrangement removes machining fluid adhering in a region of the workpiece by blowing with compressed air.

15. The compressed air cleaning arrangement in accordance with claim 14, wherein the compressed air cleaning arrangement is configured as a compressed air lance, wherein the compressed air lance cleans a bore of the workpiece and comprises a bar in whose head region a compressed air outlet is arranged which is in communication with a compressed air source through a longitudinal bore of the bar, wherein the compressed air outlet of the compressed air cleaning arrangement conducts the compressed air flow obliquely rearwardly from a head region of the compressed air cleaning arrangement, for which purpose an obliquely rearwardly directed compressed air passage leads to the compressed air outlet.

16. The compressed air cleaning arrangement in accordance with claim 14, wherein the compressed air cleaning arrangement is configured as an outer periphery cleaner which cleans the outer periphery of the workpiece with compressed air, wherein the outer periphery cleaner has a compressed air outlet which extends in the form of one or more inwardly directed nozzles about a central cleaning region, and wherein the one or more nozzles are directed obliquely inwardly.

17. The compressed air cleaning arrangement in accordance with claim 14, comprising a travel arrangement by which the compressed air cleaning arrangement travels with respect to the workpiece, wherein the compressed air cleaning arrangement has a control for actuating the compressed air cleaning arrangement and for traveling the compressed air cleaning arrangement.

18. The compressed air cleaning arrangement in accordance with claim 17, wherein the control first travels the compressed air cleaning arrangement into the bore of the workpiece at a first speed, and thereupon travels it out again at a second slower speed, and/or wherein the control first moves the compressed air cleaning arrangement along the outer periphery of the workpiece in a first direction at a first speed, and thereupon travels it back in the opposite direction again at a second, slower speed.

19. The compressed air cleaning arrangement in accordance with claim 17, wherein the travel speed and/or the air pressure is regulated in dependence on the workpiece diameter at this point, and/or wherein the travel speed and/or the air pressure is/are varied in dependence on the travel position, and/or wherein compressed air is only blown out on the movement in one direction.

20. The compressed air cleaning arrangement in accordance with claim 14, comprising a compressed air lance and an outer periphery cleaner, wherein the compressed air lance and an outer periphery cleaner travel independently of one another.

21. A method for machining a workpiece, comprising the steps:
gear-cutting the workpiece; and
removing machining fluid adhering in a region of the workpiece by blowing with compressed air.

22. The centrifugal station in accordance with claim 1, wherein the centrifugal station is coupled to a gear cutting machine, wherein the gear-cutting machine has a main machining station on which the workpieces are gear cut and from which they are transported via a transport arrangement, wherein the transport arrangement comprises a transfer device, to the centrifugal station.
